(19) United States
(12) Patent Application Publication
(10) Pub. No.: US 2026/0052204 A1
(43) Pub. Date: Feb. 19, 2026

(54) SCREEN BODY HOLDER

(71) Applicant: Shenzhen Yuecheng Yuezhen Industrial Development Co., Ltd, Guangdong (CN)

(72) Inventor: Zhanyue LI, Guangdong (CN)

(21) Appl. No.: 19/001,800

(22) Filed: Dec. 26, 2024

(30) Foreign Application Priority Data
Aug. 15, 2024 (CN) 202421980683.7

(51) Int. Cl. H04M 1/04

(52) U.S. Cl. CPC H04M 1/04

(57) ABSTRACT

A screen body holder includes two fixing clampers and a holder frame; a placing slot is downwardly formed from the top of the fixing clamper, and in a first direction, each of two ends of the placing slot includes an opening; placing slots of the two fixing clampers are disposed opposite each other in the first direction; locking slots are disposed on one of two slot walls of each placing slot, and the plurality of locking slots are spaced in a vertical direction; a to-be-supported screen body is capable of being obliquely placed in the placing slot and is engaged with one of the plurality of locking slots; two ends of the holder frame are connected to the two fixing clampers, respectively.

### CROSS-REFERENCE TO RELATED APPLICATION

This application claims priority to Chinese Patent Application No. 202421980683.7 filed Aug. 15, 2024, the disclosure of which is incorporated herein by reference in its entirety.

### TECHNICAL FIELD

The present disclosure relates to the field of holders and, for example, to a screen body holder.

### BACKGROUND

The screen body holder, generally referred to as a holder for a lazy person, is designed according to different types of electronic products and is used for supporting these electronic products. The screen body holder is mainly a mobile phone holder or a tablet computer holder. The mobile phone or the tablet computer can be stably placed on the desktop through the support of the screen body holder so that users can conveniently use the mobile phone or the tablet computer and the comfort of use can also be improved.

The screen body holder in the related art generally fixes the mobile phone or the tablet computer by using a magnetic suction part or a clamping assembly. When the fixed angle of the mobile phone or the tablet computer needs to be adjusted, the screen body holder needs to be disassembled and adjusted, and the fixing structure and the angle adjustment structure of the screen body holder are complicated and difficult to operate, thereby affecting the use experience of the user.

### SUMMARY

The present disclosure provides a screen body holder to solve the problem in the related art that when the fixed angle of a mobile phone or a tablet computer needs to be adjusted, the screen body holder needs to be disassembled and adjusted, and the fixing structure and the angle adjustment structure of the screen body holder are complicated and difficult to operate, thereby affecting the use experience of the user.

The present disclosure provides a screen body holder. The screen body holder is used for supporting a to-be-supported screen body and includes two fixing clampers and a holder frame.

A placing slot is downwardly formed from the top of each fixing clamper, and the placing slot extends through a respective fixing clamper in a first direction. The placing slots of the two fixing clampers are disposed opposite each other in the first direction. Multiple locking slot are disposed on one of two slot walls of each placing slot, and the multiple locking slots are spaced in the vertical direction. The placing slots are configured to enable the to-be-supported screen body to be obliquely placed in the placing slot and one of the multiple locking slots is configured to engage with the to-be-supported screen body.

Two ends of the holder frame are connected to the two fixing clampers, respectively.

As an optional solution of the above screen body holder, each fixing clamper includes a first side plate, a second side plate, and a connecting plate. Two ends of the connecting plate are connected to the first side plate and the second side plate respectively to enable the first side plate, the second side plate, and the connecting plate to form a U-shaped structure. The placing slot is disposed on the connecting plate, and the multiple locking slots are located on the second side plate. The holder frame is connected to the first side plate and is located on a side, away from the second side plate, of the first side plate.

As an optional solution of the above screen body holder, each fixing clamper further includes a reinforcing plate. The reinforcing plate is connected to the first side plate, the second side plate, and the connecting plate.

As an optional solution of the above screen body holder, the holder frame includes a first connecting section, a second connecting section, and a transverse connecting section. Two ends of the transverse connecting section are connected to the first connecting section and the second connecting section respectively to enable the holder frame to form a U-shaped structure. The free end of the first connecting section and the free end of the second connecting section are connected to the two fixing clampers, respectively.

As an optional solution of the above screen body holder, a stop plate protrudes upwardly from the transverse connecting section. One end of the to-be-supported screen body is capable of being placed on the first connecting section and the second connecting section and abutting the stop plate, and the other end of the to-be-supported screen body is capable of abutting the two fixing clampers to enable the to-be-supported screen body to be obliquely placed with respect to the holder frame.

As an optional solution of the above screen body holder, a limiting protrusion protrudes from a side, facing the fixing clamper, of the stop plate. The limiting protrusion is used for downwardly abutting and limiting the to-be-supported screen body.

As an optional solution of the above screen body holder, a first step portion is disposed on the first connecting section, and a second step portion is disposed on the second connecting section. The first step portion and the second step portion are located between the stop plate and the fixing clamper. One end of the to-be-supported screen body is capable of being placed on the first connecting section and the second connecting section and abutting the first step portion and the second step portion, and the other end of the to-be-supported screen body is capable of abutting the two fixing clambers to enable the to-be-supported screen body to be obliquely placed with respect to the holder frame.

As an optional solution of the above screen body holder, a wire clamp opening is disposed on the transverse connecting section.

As an optional solution of the above screen body holder, the fixing clamper and the holder frame are integrally formed.

The present disclosure further provides a screen body holder. The screen body holder is used for supporting a to-be-supported screen body and includes two fixing clampers and a holder frame.

A placing slot is downwardly formed from a top of each fixing clamper, and the placing slot extends through a respective fixing clamper in a first direction. A support post is disposed on each fixing clamper, and support posts on the two fixing clampers are disposed in a same direction. Placing slots of the two fixing clampers are disposed opposite each other in the first direction. The placing slots are configured to enable the to-be-supported screen body to be obliquely placed in the placing slots; and the support post is capable of abutting the to-be-supported screen body.

Two ends of the holder frame are connected to the two fixing clampers, respectively.

As an optional solution of the above screen body holder, each fixing clamper includes a first side plate, a second side plate, and a connecting plate, and two ends of the connecting plate are connected to the first side plate and the second side plate respectively to enable the first side plate, the second side plate, and the connecting plate to form a U-shaped structure. The placing slot is disposed on the connecting plate. The holder frame is connected to the first side plate and is located on a side, away from the second side plate, of the first side plate.

As an optional solution of the above screen body holder, each fixing clamper further includes a reinforcing plate. The reinforcing plate is connected to the first side plate, the second side plate, and the connecting plate.

As an optional solution of the above screen body holder, the holder frame includes a first connecting section, a second connecting section, and a transverse connecting section. Two ends of the transverse connecting section are connected to the first connecting section and the second connecting section respectively to enable the holder frame to form a U-shaped structure. The free end of the first connecting section and the free end of the second connecting section are connected to the two fixing clampers, respectively.

As an optional solution of the above screen body holder, a stop plate protrudes upwardly from the transverse connecting section. One end of the to-be-supported screen body is capable of being placed on the first connecting section and the second connecting section and abutting the stop plate, and the other end of the to-be-supported screen body is capable of abutting the two fixing clampers to enable the to-be-supported screen body to be obliquely placed with respect to the holder frame.

As an optional solution of the above screen body holder, a limiting protrusion protrudes towards from a side, facing the fixing clamper, of the stop plate. The limiting protrusion is used for downwardly abutting and limiting the to-be-supported screen body.

As an optional solution of the above screen body holder, a first step portion is disposed on the first connecting section, and a second step portion is disposed on the second connecting section. The first step portion and the second step portion are located between the stop plate and the fixing clamper. One end of the to-be-supported screen body is capable of being placed on the first connecting section and the second connecting section and abutting the first step portion and the second step portion, and the other end of the to-be-supported screen body is capable of abutting the two fixing clambers to enable the to-be-supported screen body to be obliquely placed with respect to the holder frame.

As an optional solution of the above screen body holder, a wire clamp opening is disposed on the transverse connecting section.

As an optional solution of the above screen body holder, the fixing clamper and the holder frame are integrally formed.

### BRIEF DESCRIPTION OF DRAWINGS

FIG. 1 is a structure view of a screen body holder provided by the present disclosure.

In the drawings:
1 fixing clamper
11 placing slot
111 locking slot
12 first side plate
13 second side plate
14 connecting plate
15 reinforcing plate
16 support post
2 holder frame
21 first connecting section
211 first step portion
22 second connecting section
221 second step portion
23 transverse connecting section
231 stop plate
232 limiting protrusion
233 wire clamp opening

### DETAILED DESCRIPTION

Solutions of the present disclosure are clearly and completely described below in conjunction with the drawings. Apparently, embodiments described herein are part, not all, of the embodiments of the present disclosure. Based on the embodiments of the present utility mode, all other embodiments obtained by those of ordinary skill in the art without creative work are within the scope of the present utility mode.

In the description of the present disclosure, it is to be noted that orientations or position relations indicated by terms such as “center”, “upper”, “lower”, “left”, “right”, “vertical”, “horizontal”, “in”, and “out” are orientations or position relations based on the drawings. These orientations or position relations are intended only to facilitate the description of the present disclosure and simplify the description and not to indicate or imply that a device or element referred to must have such specific orientations or must be configured or operated in such specific orientations. Thus, these orientations or position relations are not to be construed as limiting the present disclosure. In addition, terms such as “first” and “second” are used only for the purpose of description and are not to be construed as indicating or implying relative importance. The terms “first position” and “second position” are two different positions. Moreover, when a first feature is described as “on”, “above” or “over” a second feature, the first feature is right on, above or over the second feature, the first feature is obliquely on, above or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature.

In the description of the present disclosure, it is to be noted that unless otherwise expressly specified and limited, terms “mounted”, “connected to each other”, and “connected” are to be understood in a broad sense, for example, as “securely connected”, “detachably connected”, or “integrally connected”; “mechanically connected” or “electrically connected”; “directly connected to each other” or “indirectly connected to each other via an intermediary”; or “intra-connected between two components”. For those of ordinary skill in the art, specific meanings of the preceding terms in the present disclosure may be understood based on specific situations.

The embodiments of the present disclosure will be described in detail below. Examples of the embodiments are illustrated in the drawings, where the same or similar reference numerals indicate the same or similar elements or elements having the same or similar functions. The embodiments described below with reference to the drawings are illustrative, intended to explain the present disclosure, and not to be construed as limiting the present disclosure.

The embodiments provide a screen body holder. The screen body holder is used for supporting a to-be-supported screen body. Optionally, the to-be-supported screen body is a tablet computer or a mobile phone. Of course, the to-be-supported screen body may be other electronic products, which is not specifically limited in the embodiments.

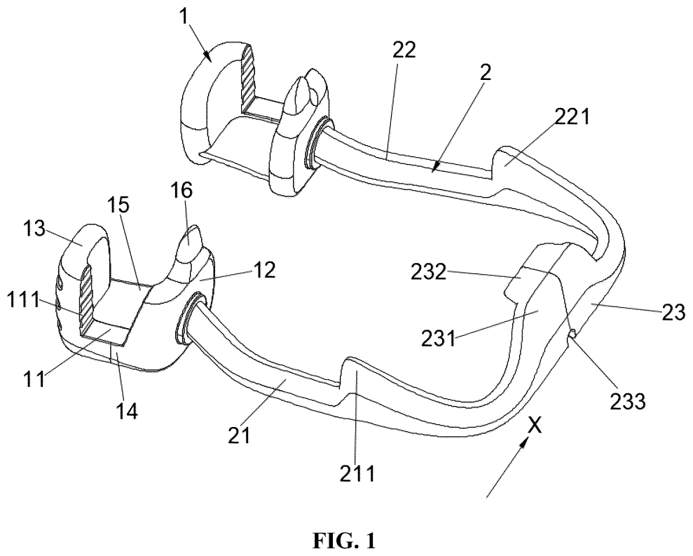

As shown in FIG. 1, the screen body holder includes fixing clampers 1 and a holder frame 2. A placing slot 11 is downwardly disposed on the top of the fixing clamper 1, and the placing slot 11 is disposed therethrough in the first direction (the direction X in the figure). Two fixing clampers 1 are disposed, and the placing slots 11 of the two fixing clampers 1 are disposed opposite each other in the first direction. A locking slot 111 is disposed on one of two slot walls of the placing slot 11, multiple locking slots 111 are disposed, and the multiple locking slots 111 are spaced in the vertical direction. The to-be-supported screen body is capable of being obliquely placed in the placing slot 11 and is configured to engage with one of the multiple locking slots 111. Therefore, through the gravity of the to-be-supported screen body and the locking slots 111 on two fixing clampers 1, the to-be-supported screen body can be stably fixed, and by engaging the to-be-supported screen body with the locking slots 111 with different heights, the fixed angle of the to-be-supported screen body can be rapidly adjusted. The adjustment operation of the fixed angle is simple and convenient for users to use. At the same time, two ends of the holder frame 2 are connected to the two fixing clampers 1, respectively, so the stability of the two fixing clampers 1 can be improved through the holder frame 2 when the two fixing clampers 1 are placed on the plane, thereby preventing the fixing clampers 1 from falling over after the to-be-supported screen body is placed on the fixing clampers 1. Optionally, the fixing clampers 1 and the holder frame 2 are integrally formed to enable the overall structure of the screen body holder stable and reduce the manufacturing difficulty of the screen body holder, thereby resulting in stable product quality and high production efficiency.

In some embodiments, the fixing clamper 1 includes a first side plate 12, a second side plate 13, and a connecting plate 14. Two ends of the connecting plate 14 are connected to the first side plate 12 and the second side plate 13 respectively to enable the first side plate 12, the second side plate 13, and the connecting plate 14 to form a U-shaped structure. The placing slot 11 is disposed on the connecting plate 14, that is, the to-be-supported screen body can be inserted into and then fixed onto the opening of the fixing clamper 1, so that the first side plate 12 and the second side plate 13 can protect the to-be-supported screen body. The locking slot 111 is located on the second side plate 13, and the holder frame 2 is connected to the first side plate 12 and is located on a side, away from the second side plate 13, of the first side plate 12, so when one end of the to-be-supported screen body is configured to engage with the locking slot 111, the other end can be tilted towards the holder frame 2, thereby achieving the stable placement of the whole screen body holder on the horizontal plane through such a structure. Specifically, the U-shaped openings of the two fixing clampers 1 are disposed opposite to each other in the first direction. Optionally, the fixing clamper 1 further includes a reinforcing plate 15. The reinforcing plate 15 is connected to the first side plate 12, the second side plate 13, and the connecting plate 14 to enhance the connection strength among the first side plate 12, the second side plate 13, and the connecting plate 14, thereby preventing the fixing clamper 1 from being deformed by gravity. At the same time, the reinforcing plate 15 is lower than the slot bottom of the placing slot 11 so that the reinforcing plate 15 does not interfere with the to-be-supported screen body when the to-be-supported screen body is placed in the placing slot 11.

In some embodiments, the holder frame 2 includes a first connecting section 21, a second connecting section 22, and a transverse connecting section 23. Two ends of the transverse connecting section 23 are connected to the first connecting section 21 and the second connecting section 22 respectively to enable the holder frame 2 to form a U-shaped structure. The free end of the first connecting section 21 and the free end of the second connecting section 22 are connected to the two fixing clampers 1, respectively. In this manner, through the U-shaped structure of the holder frame 2, the support capacity of the holder frame 2 can be improved, thereby preventing the screen body holder from falling over after the to-be-supported screen body is mounted on the screen body holder. Optionally, a wire clamp opening 233 is disposed on the transverse connecting section 23 so that the wires connected to the to-be-supported screen body can be clamped into the wire clamp opening 233, thereby achieving the clamping and fixing of the wires and improving the use experience of the user.

In some embodiments, a stop plate 231 protrudes upwardly from the transverse connecting section 23. One end of the to-be-supported screen body is capable of being placed on the first connecting section 21 and the second connecting section 22 and abutting the stop plate 231, and the other end of the to-be-supported screen body is capable of abutting the two fixing clampers 1 to enable the to-be-supported screen body to be obliquely placed with respect to the holder frame 2. In this manner, by supporting the to-be-supported screen body through the first connecting section 21, the second connecting section 22, the stop plate 231, and two fixing clampers 1, the to-be-supported screen body can be placed obliquely and even placed flat to enable the angle between the to-be-supported screen body and the horizontal plane to be small, thereby making operation and use convenient for users. Optionally, the angle between the to-be-supported screen body and the horizontal plane ranges from 15° to 25°. Further, optionally, a limiting protrusion 232 protrudes from a side, facing the fixing clamper 1, of the stop plate 231. The limiting protrusion 232 is used for downwardly abutting and limiting the to-be-supported screen body. In this manner, the to-be-supported screen body can be limited through the limiting protrusion 232, thereby preventing the to-be-supported screen body from being tilted upwards and sliding away from the stop plate 231 under the action of the gravity of the to-be-supported screen body itself.

In some embodiments, a first step portion 211 is disposed on the first connecting section 21, and a second step portion 221 is disposed on the second connecting section 22. The first step portion 211 and the second step portion 221 are located between the stop plate 231 and the fixing clampers 1. One end of the to-be-supported screen body is capable of being placed on the first connecting section 21 and the second connecting section 22 and abutting the first step portion 211 and the second step portion 221, and the other end of the to-be-supported screen body is capable of abutting the two fixing clambers 1 to enable the to-be-supported screen body to be obliquely placed with respect to the holder frame 2. In this manner, by supporting the to-be-supported screen body through the first connecting section 21, the second connecting section 22, the stop plate 231, and two fixing clampers 1, the to-be-supported screen body can be placed obliquely and even placed flat to form a certain angle between the to-be-supported screen body and the horizontal plane, thereby making operation and use convenient for users. Optionally, the angle between the to-be-supported screen body and the horizontal plane ranges from 30° to 40°.

In some embodiments, a support post 16 is disposed on the fixing clamper 1. Support posts 16 on the two fixing clampers 1 are disposed in the same direction. The support post 16 is capable of abutting the to-be-supported screen body. In this manner, the support post 16 can provide auxiliary support for the to-be-supported screen body, thereby improving the stability of the to-be-supported screen body when the to-be-supported screen body is mounted on the screen body holder.

Apparently, the preceding embodiments of the present disclosure are examples for clearly illustrating the present disclosure and are not intended to limit the implementations of the present disclosure. Those of ordinary skill in the art can make changes or alterations of different forms based on the above description. All implementations cannot be and do not need to be exhausted here. Any modifications, equivalent substitutions, and improvements made within the spirit and principle of the present disclosure fall within the scope of the claims of the present disclosure.

What is claimed is:

1. A screen body holder, for supporting a to-be-supported screen body and comprising:
two fixing clampers, wherein a placing slot is downwardly formed from a top of each fixing clamper, and the placing slot extends through a respective fixing clamper in a first direction; placing slots of the two fixing clampers are disposed opposite each other in the first direction; a plurality of locking slots are disposed on one of two slot walls of each placing slot, and the plurality of locking slots are spaced in a vertical direction; the placing slots are configured to enable the to-be-supported screen body to be obliquely placed in the placing slots, and one of the plurality of locking slots is configured to engage with the to-be-supported screen body; and
a holder frame, wherein two ends of the holder frame are connected to the two fixing clampers, respectively.

2. The screen body holder according to claim 1, wherein each fixing clamper comprises a first side plate, a second side plate, and a connecting plate, and two ends of the connecting plate are connected to the first side plate and the second side plate respectively to enable the first side plate, the second side plate, and the connecting plate to form a U-shaped structure; the placing slot is disposed on the connecting plate, and the plurality of locking slots are located on the second side plate; the holder frame is connected to the first side plate and is located on a side, away from the second side plate, of the first side plate.

3. The screen body holder according to claim 2, wherein each fixing clamper further comprises a reinforcing plate, and the reinforcing plate is connected to the first side plate, the second side plate, and the connecting plate.

4. The screen body holder according to claim 1, wherein the holder frame comprises a first connecting section, a second connecting section, and a transverse connecting section, and two ends of the transverse connecting section are connected to the first connecting section and the second connecting section respectively to enable the holder frame to form a U-shaped structure; a free end of the first connecting section and a free end of the second connecting section are connected to the two fixing clampers, respectively.

5. The screen body holder according to claim 4, wherein a stop plate protrudes upwardly from the transverse connecting section, one end of the to-be-supported screen body is capable of being placed on the first connecting section and the second connecting section and abutting the stop plate, and the other end of the to-be-supported screen body is capable of abutting the two fixing clampers to enable the to-be-supported screen body to be obliquely placed with respect to the holder frame.

6. The screen body holder according to claim 5, wherein a limiting protrusion protrudes from a side of the stop plate facing the fixing clamper, and the limiting protrusion is used for downwardly abutting and limiting the to-be-supported screen body.

7. The screen body holder according to claim 4, wherein a first step portion is disposed on the first connecting section, a second step portion is disposed on the second connecting section, and the first step portion and the second step portion are located between the stop plate and the fixing clamper; the one end of the to-be-supported screen body is capable of being placed on the first connecting section and the second connecting section and abutting the first step portion and the second step portion, and the other end of the to-be-supported screen body is capable of abutting the two fixing clambers to enable the to-be-supported screen body to be obliquely placed with respect to the holder frame.

8. The screen body holder according to claim 4, wherein a wire clamp opening is disposed on the transverse connecting section.

9. The screen body holder according to claim 1, wherein the fixing clampers and the holder frame are integrally formed.

10. The screen body holder according to claim 2, wherein the fixing clampers and the holder frame are integrally formed.

11. The screen body holder according to claim 3, wherein the fixing clampers and the holder frame are integrally formed.

12. The screen body holder according to claim 4, wherein the fixing clampers and the holder frame are integrally formed.

13. A screen body holder, for supporting a to-be-supported screen body and comprising:
two fixing clampers, wherein a placing slot is downwardly formed from a top of each fixing clamper, and the placing slot extends through a respective fixing clamper in a first direction; a support post is disposed on each fixing clamper, support posts on the two fixing clampers are disposed in a same direction; placing slots of the two fixing clampers are disposed opposite each other in the first direction; the placing slots are configured to enable the to-be-supported screen body to be obliquely placed in the placing slots; and the support post is capable of abutting the to-be-supported screen body; and
a holder frame, wherein two ends of the holder frame are connected to the two fixing clampers, respectively.

14. The screen body holder according to claim 13, wherein each fixing clamper comprises a first side plate, a second side plate, and a connecting plate, and two ends of the connecting plate are connected to the first side plate and the second side plate respectively to enable the first side plate, the second side plate, and the connecting plate to form a U-shaped structure; the placing slot is disposed on the connecting plate; the holder frame is connected to the first side plate and is located on a side, away from the second side plate, of the first side plate.

15. The screen body holder according to claim 14, wherein each fixing clamper further comprises a reinforcing plate, and the reinforcing plate is connected to the first side plate, the second side plate, and the connecting plate.

16. The screen body holder according to claim 13, wherein the holder frame comprises a first connecting section, a second connecting section, and a transverse connecting section, and two ends of the transverse connecting section are connected to the first connecting section and the second connecting section respectively to enable the holder frame to form a U-shaped structure; a free end of the first connecting section and a free end of the second connecting section are connected to the two fixing clampers, respectively.

17. The screen body holder according to claim 16, wherein a stop plate protrudes upwardly from the transverse connecting section, one end of the to-be-supported screen body is capable of being placed on the first connecting section and the second connecting section and abutting the stop plate, and the other end of the to-be-supported screen body is capable of abutting the two fixing clampers to enable the to-be-supported screen body to be obliquely placed with respect to the holder frame.

18. The screen body holder according to claim 17, wherein a limiting protrusion protrudes from a side of the stop plate facing the fixing clamper, and the limiting protrusion is used for downwardly abutting and limiting the to-be-supported screen body.

19. The screen body holder according to claim 16, wherein a first step portion is disposed on the first connecting section, a second step portion is disposed on the second connecting section, and the first step portion and the second step portion are located between the stop plate and the fixing clamper; the one end of the to-be-supported screen body is capable of being placed on the first connecting section and the second connecting section and abutting the first step portion and the second step portion, and the other end of the to-be-supported screen body is capable of abutting the two fixing clambers to enable the to-be-supported screen body to be obliquely placed with respect to the holder frame.

20. The screen body holder according to claim 16, wherein a wire clamp opening is disposed on the transverse connecting section.
